(19) United States
(12) Patent Application Publication
(10) Pub. No.: US 2025/0103803 A1
(43) Pub. Date: Mar. 27, 2025

(54) TRAINING METHOD FOR TEXT COMBINATION DETERMINING MODEL AND TEXT COMBINATION DETERMINING METHOD

(71) Applicant: ANT WEALTH (SHANGHAI) FINANCIAL INFORMATION SERVICES CO., LTD., Shanghai (CN)

(72) Inventor: Zhigang JING, Shanghai (CN)

(21) Appl. No.: 18/974,630

(22) Filed: Dec. 9, 2024

Related U.S. Application Data
(63) Continuation of application No. PCT/CN2023/131651, filed on Nov. 14, 2023.

(30) Foreign Application Priority Data
Nov. 22, 2022 (CN) 202211465160.4

(51) Int. Cl. G06F 40/205; G06N 3/0455

(52) U.S. Cl. CPC G06F 40/205; G06N 3/0455

(57) ABSTRACT

Implementations of the present specification disclose a training method and apparatus for a text combination determining model, a storage medium, and an electronic device. In the present specification, at least one positive sample set that cannot be combined and a negative sample set that can be combined are constructed, and the text combination determining model is trained based on the at least one positive sample set and the at least one negative sample set, until the text combination determining model converges, so that the text combination determining model can be used in a task of determining whether to combine the two texts.

### TECHNICAL FIELD

The present specification relates to the field of natural language processing technologies, and in particular, to a training method for a text combination determining model and a text combination determining method.

### BACKGROUND

Usually, a long text can be segmented into a plurality of sentences by using “.”, “!”, “?”, and even “,”. However, entered texts may be segmented incorrectly due to very complex text generation environments. For example, users enter texts on touchscreens of mobile terminals, but incorrectly use segmentation symbols, use a large number of spaces, and incorrectly use line breaks. For another example, users enter texts through voices, but poor conditions of voice entering environments or abnormal stops during entering of the users cause incorrect segmentation of the texts entered through voices. Therefore, determining whether two sentences, namely, two short texts can be combined is always one of basic tasks in the artificial intelligence natural language processing field, and is a basic support technology of upper-layer applications such as text duplicate checking and intelligent question and answer.

### SUMMARY

Implementations of the present specification provide a text combination determining method and apparatus, a storage medium, and an electronic device, to train a text combination determining model, improve robustness of the text combination determining model, and improve accuracy of determining, by the text combination determining model, whether two texts can be combined. Technical solutions are as follows: According to a first aspect, an implementation of the present specification provides a training method for a text combination determining model. The method includes: obtaining at least one positive sample set, and obtaining at least one negative sample set, a positive sample set in the at least one positive sample set including two texts that cannot be combined, and a negative sample set in the at least one negative sample set including two texts that can be combined; and training the text combination determining model based on the at least one positive sample set and the at least one negative sample set, until the text combination determining model converges.

According to a second aspect, an implementation of the present specification provides a text combination determining method. The method includes: obtaining two to-be-detected texts; and inputting the two to-be-detected texts into a text combination determining model, to obtain a determining result regarding whether the two to-be-detected texts can be combined. The text combination determining model is a model obtained through training in the training method for a text combination determining model according to the first aspect.

According to a third aspect, an implementation of the present specification provides a training apparatus for a text combination determining model. The apparatus includes: a sample acquisition module, configured to: obtain at least one positive sample set, and obtain at least one negative sample set, a positive sample set in the at least one positive sample set including two texts that cannot be combined, and a negative sample set in the at least one negative sample set including two texts that can be combined; and a model training module, configured to train the text combination determining model based on the at least one positive sample set and the at least one negative sample set, until the text combination determining model converges.

According to a fourth aspect, an implementation of the present specification provides a text combination determining apparatus. The apparatus includes: a text acquisition module, configured to obtain two to-be-detected texts; and a result acquisition module, configured to input the two to-be-detected texts into a text combination determining model, to obtain a determining result regarding whether the two to-be-detected texts can be combined. The text combination determining model is a model obtained through training in the training method for a text combination determining model according to the first aspect.

According to a fifth aspect, an implementation of the present specification provides a computer storage medium. The computer storage medium stores a plurality of instructions, and the instructions are adapted to be loaded by a processor and to perform steps of the above methods.

According to a sixth aspect, an implementation of the present specification provides a computer program product. The computer program product stores a plurality of instructions, and the instructions are adapted to be loaded by a processor and to perform steps of the above methods.

According to a seventh aspect, an implementation of the present specification provides an electronic device. The electronic device can include a processor and a memory. The memory stores a computer program, and the computer program is adapted to be loaded by the processor and to perform the steps of the above methods.

Beneficial effects brought by the technical solutions provided in some implementations of the present specification include at least the following: In the implementations of the present specification, at least one positive sample set and at least one negative sample set are properly constructed. A positive sample set in the at least one positive sample set includes texts that cannot be combined, and a negative sample set in the at least one negative sample set includes texts that can be combined. The text combination determining model can learn, in a self-supervised manner based on the at least one positive sample set and the at least one negative sample set, whether two texts have a relationship of whether the two texts can be combined, until the text combination determining model converges, to improve training efficiency of the text combination determining model. In addition, the text combination determining model is trained for a plurality of rounds based on at least one positive sample and at least one negative sample, so that the text combination determining model whose training is completed has relatively good interference resistance and robustness, and has relatively high accuracy of executing a task of determining whether to combine two texts, to obtain a combined text with complete semantics, and facilitate reading and understanding by a user.

### BRIEF DESCRIPTION OF DRAWINGS

To describe the technical solutions in the implementations of the present specification or in related technologies more clearly, the following briefly describes the accompanying drawings needed for describing the implementations or the related technologies. Clearly, the accompanying drawings in the following descriptions show merely some implementations of the present specification, and a person of ordinary skill in the art can still derive other drawings from these accompanying drawings without creative efforts.

FIG. 1 is a schematic flowchart illustrating that a text combination determining model determines whether texts can be combined according to an implementation of the present specification;

FIG. 2 illustrates a training method for a text combination determining model according to an implementation of the present specification;

FIG. 3 is a schematic flowchart illustrating obtaining of a negative sample set according to an implementation of the present specification;

FIG. 4 is a schematic flowchart illustrating obtaining of a negative sample set according to an implementation of the present specification;

FIG. 5 is a schematic structural diagram illustrating a text combination determining model according to an implementation of the present specification;

FIG. 6 is a schematic flowchart illustrating that a text combination determining model determines whether texts can be combined according to an implementation of the present specification;

FIG. 7 is a schematic diagram illustrating a scenario of a text combination determining method according to an implementation of the present specification;

FIG. 8 is a schematic flowchart illustrating a text combination determining method according to an implementation of the present specification;

FIG. 9 is a schematic structural diagram illustrating a training apparatus for a text combination determining model according to an implementation of the present specification;

FIG. 10 is a schematic structural diagram illustrating a text combination determining apparatus according to an implementation of the present specification; and

FIG. 11 is a schematic structural diagram illustrating an electronic device according to an implementation of the present specification.

### DESCRIPTION OF IMPLEMENTATIONS

The following clearly and completely describes the technical solutions in the implementations of the present specification with reference to the accompanying drawings in the implementations of the present specification. Clearly, the described implementations are merely some rather than all of the implementations of the present specification. All other implementations obtained by a person of ordinary skill in the art based on the implementations of the present specification without making innovative efforts fall within the protection scope of the present specification.

In the descriptions of the present specification, it should be understood that the terms such as “first” and “second” are merely used for description, and cannot be understood as an indication or implication of relative importance. In the descriptions of the present specification, it should be noted that the terms “including”, “having”, and any other variants thereof are intended to cover non-exclusive inclusion. For example, a process, a method, a system, a product, or a device that includes a series of steps or units is not limited to the listed steps or units, but further includes, for example, an unlisted step or unit, or further includes, for example, another inherent step or unit of the process, the method, the product, or the device. A person of ordinary skill in the art can understand specific meanings of these terms in the present specification based on specific situations. In addition, in the descriptions of the present specification, unless otherwise specified, “a plurality of” means two or more. “And/Or” describes an association relationship between associated objects, and represents that three relationships can exist. For example, A and/or B can represent the following three cases: Only A exists, both A and B exist, and only B exists. The character “/” usually indicates an “or” relationship between associated objects.

The following describes the present specification in detail with reference to specific implementations.

Natural language processing (NLP) is an important direction in the computer science field and the artificial intelligence field, and studies various theories and methods that can realize effective communication between persons and computers in natural language. Natural language processing is science that integrates linguistics, computer science, and mathematics. Therefore, research in this field relates to a natural language, namely, a language daily used by people, and therefore is closely related to research in linguistics. Natural language processing technologies usually include technologies such as text processing, semantic understanding, machine translation, robot questions and answers, and knowledge graphs.

With continuous development of network technologies, artificial intelligence technologies, for example, technologies for determining whether two texts can be combined, are applied to various fields. Usually, a long text can be segmented into a plurality of sentences by using “.”, “!”, “?”, and even “,”. However, entered texts may be segmented incorrectly due to very complex text generation environments. For example, users enter texts on touchscreens of mobile terminals, but incorrectly use segmentation symbols, use a large number of spaces, and incorrectly use line breaks. For example, users enter texts through voices, but poor conditions of voice entering environments or abnormal stops during entering of the users cause incorrect segmentation of the texts entered through voices.

For example, the text entered by the user is “For this problem. I have another opinion, and I want you to hear it”. A full stop is incorrectly used between a text 1 “For this problem” and a text 2 “I have another opinion, and I want you to hear it” for segmentation. Actually, the text 1 and the text 2 need to be combined, and a correct combined text is “For this problem, I have another opinion, and I want you to hear it”.

Therefore, a text combination determining model that is used to determine whether two to-be-detected texts can be combined emerges accordingly. FIG. 1 is a schematic flowchart illustrating that a text combination determining model determines whether texts can be combined according to an implementation of the present specification. A text 1011 and a text 1012 are input into a text combination determining model 102, so that the text combination determining model 102 determines whether the text 1011 and the text 1012 can be combined, and outputs a determining result 103. The determining result 103 includes two results: “The text 1011 and the text 1012 can be combined” and “The text 1011 and the text 1012 cannot be combined”.

For example, the entered text 1011 is “For this problem”, and the text 1012 is “I have another opinion, and I want you to hear it”. The text combination determining model 102 determines whether the text 1011 and the text 1012 can be combined, outputs the determining result 103 “The text 1011 and the text 1012 can be combined”, and correspondingly executes a subsequent text processing task.

In a related technology, there are mainly two types of text combination determining models: a model constructed based on a machine learning method in artificial intelligence, and a model constructed based on a deep learning method in artificial intelligence. For example, a determining process of the model constructed based on the machine learning method in artificial intelligence is as follows: A text combination determining problem is split into two parts: feature engineering and a classifier. Feature engineering includes parts such as preprocessing of two texts, feature extraction, and a text representation. The two texts are cleaned separately; the two texts are tokenized by using a tokenization tool; and each text is represented in a vector form in a bag-of-words method, a TF-IDF method, etc. and then is separately entered into the classifier, for example, an SVM or a decision tree, to obtain a final result. A determining process of the model constructed based on the deep learning method is as follows: Valid features respectively corresponding to two texts are obtained by using a neural network, for example, a convolutional neural network and a recurrent neural network. The two texts are separately cleaned and tokenized; the two texts are separately converted into dense distributed word vectors in a method based on a neural network idea such as word2vec; and then data corresponding to the word vectors are trained by using the neural network such as the CNN or an LSTM, to obtain a final result.

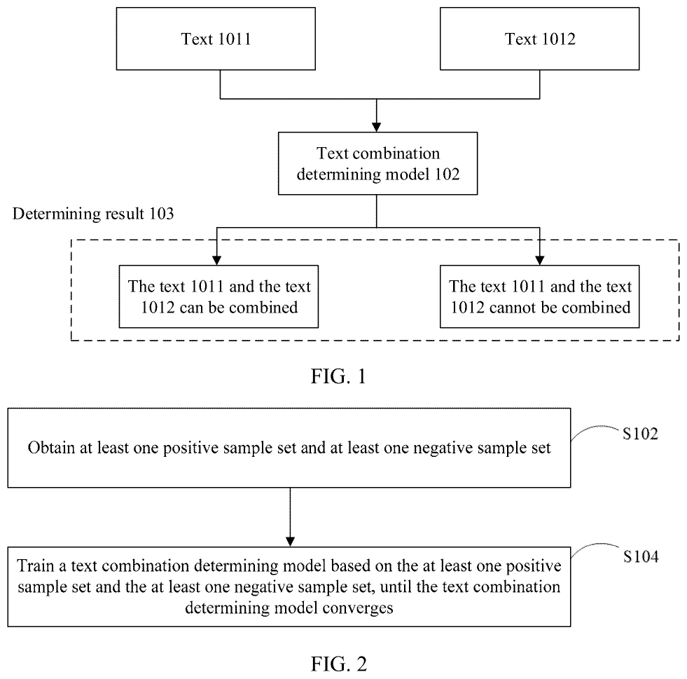

In an implementation, FIG. 2 illustrates a training method for a text combination determining model according to an implementation of the present specification. The method can be implemented based on a computer program, and can be run on a text combination determining training apparatus based on a von Neumann system. The computer program can be integrated into an application, or can be run as an independent tool application.

For example, the training method for a text combination determining model includes step S102 and step S104.

S102: Obtain at least one positive sample set and at least one negative sample set.

Each positive sample set includes two texts that cannot be combined, and the two texts have separate and complete semantics. For example, the two texts in the positive sample set are from a text paragraph published in a textbook, a newspaper, a news website, etc., and the two texts are connected by using “!” or “?”. The two texts in the positive sample set are two correctly segmented texts, and cannot be combined. When the positive sample set is input into the text combination determining model, a determining result of the text combination determining model trained to converge needs to be “the two texts cannot be combined”.

Each negative sample set includes two texts that can be combined. In other words, the two texts have an association relationship in terms of semantics, and there is complete semantics only after the two texts are combined. For example, a long text may include symbols “,”, “;”, “:”, or “-”, and the text is segmented at any one of the symbols, to obtain two texts. Each text cannot independently express a complete meaning. When the negative sample set is input into the text combination determining model, a determining result of the text combination determining model trained to converge needs to be “the two texts can be combined”. In other words, in an implementation, a method for obtaining a negative sample set including two texts that can be combined is: obtaining at least one to-be-segmented sample text; and separately segmenting the to-be-segmented sample text based on a determined symbol, predetermined or dynamically determined, in the at least one to-be-segmented sample text, to obtain at least one negative sample set. The predetermined symbol can be any one of “,”, “;”, “:”, or “-”, or other symbols as appreciated by skilled person in the related fields based on a use scenario. In the description herein, a predetermined symbol is used as an illustrative example, which does not limit the scope of the disclosure. A predetermined symbol does not mean that such a symbol is fixed or cannot be adjusted. Further, a predetermined symbol does not mean that such a symbol is determined by a user or is input by a user. For example, the predetermined symbol may be determined by a computer machine before such a symbol is sued in the processing a to-be-segmented sample text.

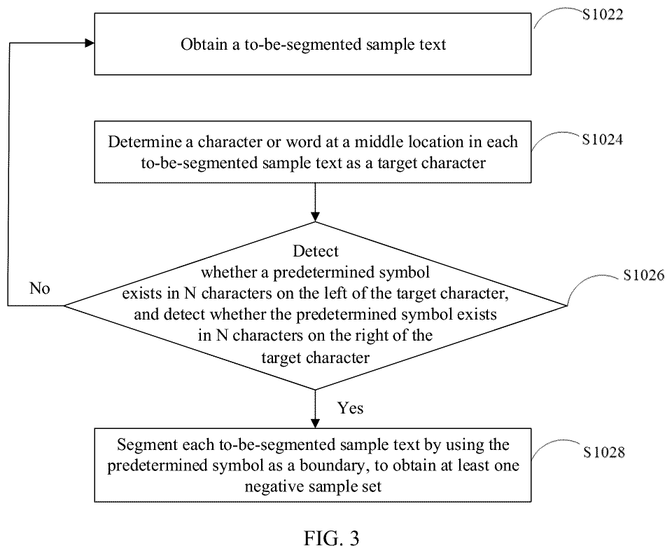

In an implementation, FIG. 3 is a schematic flowchart illustrating obtaining of a negative sample set according to an implementation of the present specification. The following steps S1022 to S1028 are included.

S1022: Obtain a to-be-segmented sample text.

The sample text includes a plurality of characters. A method for obtaining the to-be-segmented sample text can be any known and implementable method, and specific content of the sample text can be any content. A medical scenario is used as an example. The sample text includes a patient case. The sample text is at least one set of question and answer pairs for the case, and the question and answer pair includes a question asked by a patient for the case and an answer given by a doctor for the question of the patient; or the sample text is a diagnosis result and a treatment listed by a doctor for the case, for example, “ [symbol] , [symbol] , [symbol] [symbol] ” in Chinese, which corresponds to “The patient presents severe anemia symptoms, and should pay attention to diet, and pay attention to the meal time” in English.

S1024: Determine a character or word at a middle location in each to-be-segmented sample text as a target character. In the description herein, the terms “character” or “word” may be used interchangeably in referring to a unit or an element of a piece of text. In the description herein, a “character” is used to refer to a unit or an element of a piece of text for descriptive purposes, which does not limit the scope of the disclosure. A word or a phrase may also be used to as a unit or an element of a piece of text, at least for text segmentation purposes.

Each to-be-segmented sample text includes a plurality of characters, and the characters include a symbol character and a non-symbol character. The character or word at the middle location is determined as the target character based on the number of characters included in each to-be-segmented sample text and by using a read sequence as a determining sequence.

For example, the to-be-segmented sample text is “ [symbol] , [symbol] [symbol] , [symbol] ” in Chinese, which corresponds to “The patient presents severe anemia symptoms, and should pay attention to diet, and pay attention to the meal time” in English. The to-be-segmented text includes 26 characters, and the 26 characters include two characters of a symbol type. Therefore, the character “ [symbol] ” in Chinese, which corresponds to “should” in English at the 14th character is determined as the target character.

S1026: Detect whether the predetermined symbol exists in N characters on the left of the target character, and detect whether the predetermined symbol exists in N characters or words on the right of the target character.

N is a positive integer greater than 1, and is appreciated by skilled person in the related fields based on a use scenario. For example, N is 3, 4, or 5. N is used as a window. Whether the predetermined symbol exists in a left window and a right window of the target character. The predetermined symbol can be any one of “,”, “;”, “:”, or “-”, or other symbols as appreciated by skilled person in the related fields based on a use scenario.

Whether the predetermined symbol exists in the N characters on the left of the target character and whether the predetermined symbol exists in the N characters on the right of the target character can be detected in a read sequence. For example, when the read sequence is from left to right, whether the predetermined symbol exists in the N characters on the left of the target character is detected; S1028 is performed if yes; or whether the predetermined symbol exists in the N characters on the right of the target character continues to be detected if no, to be specific, the predetermined symbol does not exist in the N characters on the left of the target character; and S1028 is performed if yes; or S1022 of obtaining the to-be-segmented sample text is performed if no, to be specific, the predetermined symbol does not exist in the N characters on the left of the target character and the predetermined symbol does not exist in the N characters on the right of the target character.

S1028: Segment each to-be-segmented sample text by using the predetermined symbol as a boundary, to obtain at least one negative sample set.

When it is detected that the predetermined symbol exists in the N characters on the left of the target character, or the predetermined symbol exists in the N characters on the right of the target character, the to-be-segmented sample text is segmented by using the predetermined symbol as the boundary, to obtain two texts, and the two texts form one negative sample set.

In an implementation, when it is detected that the predetermined symbol exists in the N characters on the left of the target character, and it is detected that the predetermined symbol exists in the N characters on the right of the target character, the to-be-segmented sample text is segmented by using the predetermined symbol as the boundary, to obtain two negative sample sets.

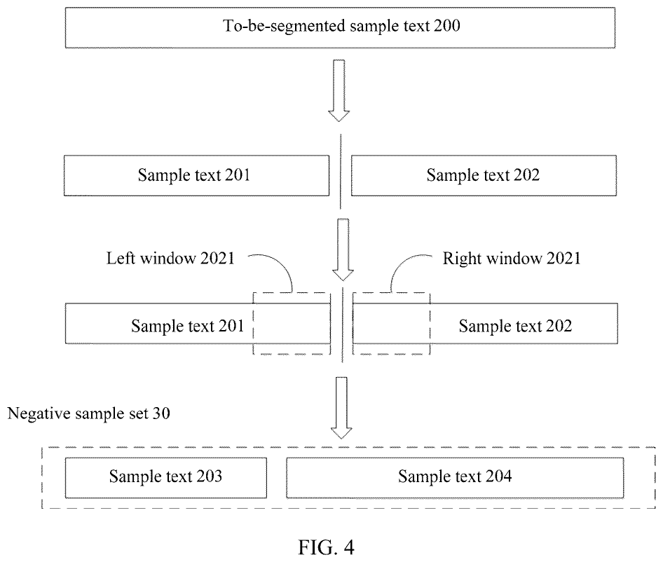

For example, FIG. 4 is a schematic flowchart illustrating obtaining of a negative sample set according to an implementation of the present specification. A to-be-segmented sample text 200 is obtained, and the to-be-segmented sample text 200 is segmented into a sample text 201 and a sample text 202 by using a target character or word at a middle location of the to-be-segmented sample text 200 as a boundary. Further, whether a predetermined symbol exists in a left window 2011 and a right window 2021 of the target character is determined. For example, in FIG. 4, the predetermined symbol exists in the left window 2011 of the target character, the to-be-segmented sample text 200 is segmented into a sample text 203 and a sample text 204 based on the predetermined symbol, and the sample text 203 and the sample text 204 are input into the text combination determining model as a negative sample set.

This implementation provides a more proper and zero-cost sample construction method, to not only reduce manual marking costs of constructing the positive sample set and the negative sample set, but also avoid a problem that the to-be-segmented sample text is less cut, more cut, and less cut if a symbol is used improperly in the sample text when text segmentation is performed simply based on the predetermined symbol.

In another implementation, each to-be-segmented sample text is segmented based on a location corresponding to each predetermined character in the to-be-segmented sample text and by using each predetermined symbol as a boundary, to obtain a negative sample set corresponding to each predetermined symbol. For example, the to-be-segmented sample text is “ [symbol] [symbol] , [symbol] , [symbol] ” in Chinese, which corresponds to “The patient presents severe anemia symptoms, and should pay attention to diet, and pay attention to the meal time” in English. The to-be-segmented text includes 26 characters, and the 26 characters include two characters of a symbol type. The to-be-segmented sample text is segmented into two negative sample sets, a first negative sample set includes “ [symbol] ” in Chinese, which corresponds to “The patient presents severe anemia symptoms” in English and “ [symbol] ” in Chinese, which corresponds to “and should pay attention to diet” in English, and the other negative sample set includes “ [symbol] ” in Chinese, which corresponds to “and should pay attention to diet” in English and “ [symbol] ” in Chinese, which corresponds to “and pay attention to the meal time” in English. A text segmentation method provided in this implementation has simple logic, and efficiency of creating the negative sample set is relatively high.

S104: Train the text combination determining model based on the at least one positive sample set and the at least one negative sample set, until the text combination determining model converges.

The at least one positive sample set and the at least one negative sample set are obtained, each positive sample set and each negative sample set are input into the text combination determining model in a training process, and the text combination determining model is adjusted based on an ideal result, until the text combination determining model converges. In the present specification, a condition that the text combination determining model converges can be a predetermined number of training rounds, or can be determined based on a stop condition in the training process. The stop condition can be that a loss function of the text combination determining model converges to an expected value, or a difference occurs after a loss function becomes stable at a value.

The training process can include transfer learning, multi-task learning, and adversarial training, and the at least one positive sample set and the at least one negative sample set include data enhancement processing. Transfer learning is a method for performing retraining on an original task by using a model trained on a similar task as a model initial point. During transfer learning, knowledge learned by the model is shared, to accelerate model learning efficiency and improve model generalization. Multi-task learning is a method for performing retraining on an original task by using a model trained on a similar task as a model initial point. Knowledge learned by the model is shared, so that migration learning can accelerate model learning efficiency and improve model generalization. Data enhancement includes a series of technologies used to generate new training samples, and the technologies are implemented by performing random jitter and scrambling on original data without changing a class label. Data enhancement is applied to increase model generalization. Adversarial training is an important representation to enhance model robustness. In an adversarial training process, some small perturbations are added to the at least one positive sample set and the at least one negative sample set, so that the text combination determining model makes a mistake. As such, the text combination determining model can adapt to a perturbation in the training process, to enhance robustness of the text combination determining model.

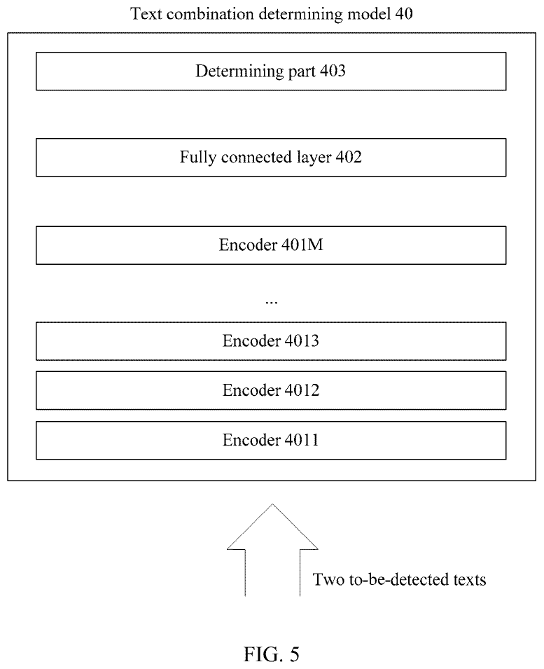

In an implementation, FIG. 5 is a schematic structural diagram illustrating a text combination determining model according to an implementation of the present specification. A text combination determining model 40 includes a plurality of encoders at an encoding layer 401, at least one fully connected layer 402, and a determining part 403. The plurality of encoders include an encoder 4011, an encoder 4012, an encoder 4013, . . . , and an encoder 401M. M is a positive integer greater than or equal to 2.

The plurality of encoders are configured to encode an input to-be-detected text, to obtain a plurality of feature vectors corresponding to each to-be-detected text. The plurality of encoders are one or more of the following: an encoder of a bidirectional encoder representations from transformers (BERT) model, an encoder of a recurrent neural network, or an encoder of a convolutional neural network. The bidirectional encoder representation from transformers (BERT) is a pre-trained language model obtained by performing multi-task training of a mask language model (MLM) and next sentence prediction (NSP) on a large-scale corpus based on transformers, and the recurrent neural network (RNN) is a recursive neural network in which sequence data are used as an input, recursion is performed in a sequence evolution direction, and all nodes (cyclic units) are linked in a chained manner. It can be understood that another type of encoder is further included in this implementation of the present specification. This is not limited thereto.

The at least one fully connected layer 402 is configured to perform full connection processing on a plurality of feature vectors corresponding to each of at least two texts, to obtain at least one connection result. In an implementation, there are one or more fully connected layers 402. The at least one fully connected layer 402 includes one or more of the following fully connected layers: a fully connected layer that sequentially connects all feature vectors, a fully connected layer that connects feature vectors corresponding to head characters of all texts, or a fully connected layer that connects a feature vector corresponding to a head character of one of the texts to a feature vector corresponding to a tail character of another one of the texts.

The determining part 403 is configured to determine, based on the at least one connection result, whether the at least two texts can be combined. For example, the determining part 403 performs constraint processing on the at least one connection result, to obtain a probability that at least two texts can be combined; and determines, based on the probability that the at least two texts can be combined, whether the at least two texts can be combined. For example, two to-be-detected texts are input into the text combination determining model 40, a plurality of feature vectors corresponding to each text are obtained by using the plurality of encoders, and the plurality of feature vectors corresponding to each text are connected by using the at least one fully connected layer 402, to obtain at least one connection result. Finally, the determining part 403 performs constraint processing on the at least one connection result, to obtain a determining result, and determines whether the two to-be-detected texts can be combined.

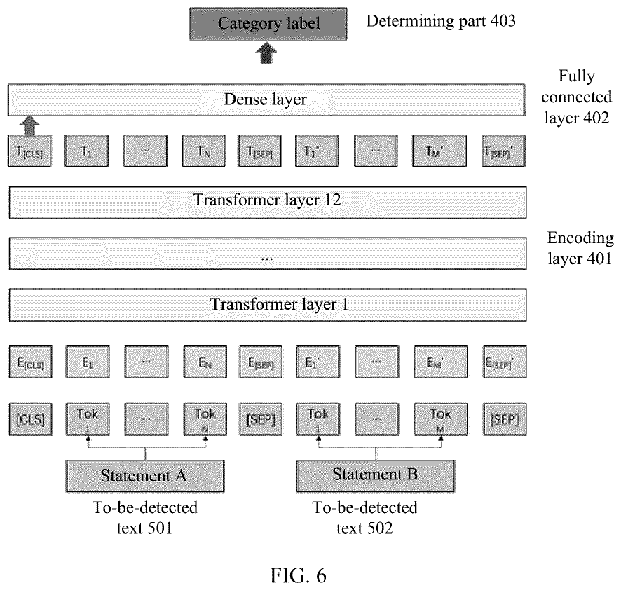

For example, FIG. 6 is a schematic flowchart illustrating that a text combination determining model determines whether texts can be combined according to an implementation of the present specification.

First, two to-be-detected texts are obtained, and are a to-be-detected text 501 and a to-be-detected text 502. Further, the to-be-detected text 501 and the to-be-detected text 502 are segmented at a minimum granularity based on a tokenization rule, to obtain a plurality of tokens corresponding to the to-be-detected text 501 and a plurality of tokens corresponding to the to-be-detected text 502; one [CLS] class is set at the beginning of the plurality of tokens corresponding to the to-be-detected text 501; the plurality of tokens corresponding to the to-be-detected text 501 and the plurality of tokens corresponding to the to-be-detected text 502 are connected by using [SEP]; and [SEP] is set as the end after the plurality of tokens corresponding to the to-be-detected text 502.

Further, a plurality of encoders at an encoding layer 401 of the text combination determining model separately encode the plurality of tokens corresponding to the to-be-detected text 501 and the plurality of tokens corresponding to the to-be-detected text 502, to obtain a vector embedding corresponding to each token. For example, the encoding layer 401 outputs one 1×1024 vector for each token as a first feature vector of the token, and then encodes a plurality of first feature vectors at a plurality of layers “transformer layers” into second feature vectors. As shown in FIG. 6, a plurality of second feature vectors including T₁ to T_{N} and T^{/}₁ to T^{/}_{M} are obtained, and there are 12 layers “transformer layers”. A method for obtaining the second feature vector based on the first feature vector can be: identifying a word class of a keyword in the to-be-detected text 501 and the to-be-detected text 502. The keyword tends to include more valid information, and a word class label includes a noun, a verb, an adjective, an adverb, a number, or a foreign word. The first feature vector is input into the encoding layer 401, and a keyword prominence operation is introduced at the encoding layer 401, to perform, based on a feature vector used to represent a keyword in the first feature vector, keyword prominence on a feature vector used to represent text information in the first feature vector, to obtain a plurality of second feature vectors corresponding to the to-be-detected text 501 and the to-be-detected text 502. It can be understood that the number of layers “transformer layers” and the number of fully connected layers 402 shown in FIG. 6 are merely an example. This implementation sets no limitation thereto.

Finally, a character [CLS] is set at the beginning of a plurality of second feature vectors corresponding to the to-be-detected text 501, a character [SEP] is used to connect a plurality of second feature vectors corresponding to the to-be-detected text 502, and a character [CLS] is set as the end. A vector statement that is set is used as an input into the fully connected layer 402, and the class label determining part 403 obtains a final output for a text combination determining task, that is, outputs a determining result regarding whether the to-be-detected text 501 and the to-be-detected text 502 can be combined.

In this implementation of the present specification, at least one positive sample set and at least one negative sample set are properly constructed. A positive sample set in the at least one positive sample set includes texts that cannot be combined, and a negative sample set in the at least one negative sample set includes texts that can be combined. The text combination determining model can learn, in a self-supervised manner based on the at least one positive sample set and the at least one negative sample set, whether two texts have a relationship of whether the two texts can be combined, until the text combination determining model converges, to improve training efficiency of the text combination determining model. In addition, the text combination determining model is trained for a plurality of rounds based on at least one positive sample and at least one negative sample, so that the text combination determining model whose training is completed has relatively good interference resistance and robustness, and has relatively high accuracy of executing a task of determining whether to combine two texts, to obtain a combined text with complete semantics, and facilitate reading and understanding by a user.

After a design idea of the text combination determining model is described in the present specification, the following briefly describes an application scenario that is set in the present application.

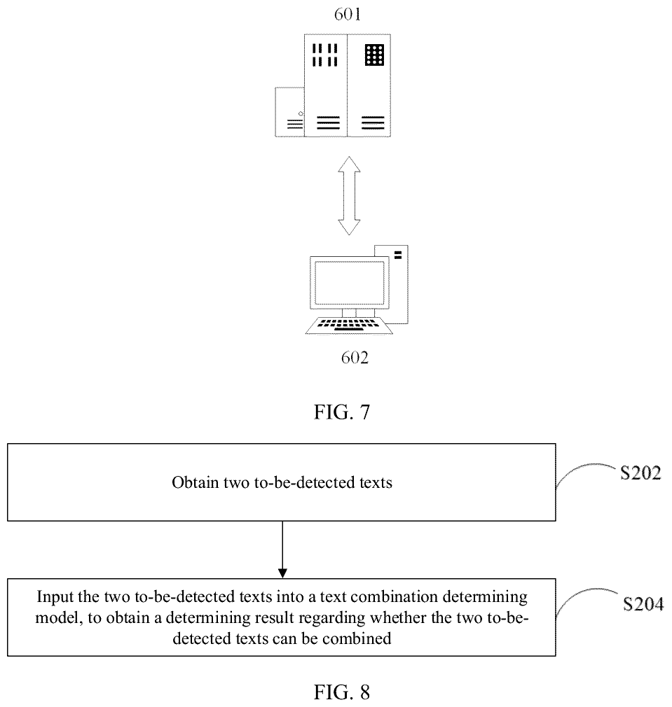

FIG. 7 is a schematic diagram illustrating an application scenario of a text combination determining model according to an implementation of the present application. The application scenario includes a terminal device 602 and a server 601. The terminal device 602 can communicate with the server 601 through a communication network. In an implementation, the communication network is a wired network or a wireless network. The terminal device 602 and the server 601 can be directly or indirectly connected in a wired or wireless communication manner. This implementation of the present specification sets no limitation thereto.

In this implementation of the present application, the terminal device 602 is an electronic device used by a user, and the electronic device can be a computer device, for example, a personal computer, a mobile phone, a tablet computer, a notebook, or an e-reader, that has a specific computing capability and on which instant messaging software and websites or social software and websites run. The terminal device 602 can be a smartphone, a tablet computer, a notebook computer, a desktop computer, a smart sound box, a smart watch, etc., but is not limited thereto.

The server 601 can be an independent physical server, or can be a server cluster or a distributed system including a plurality of physical servers, or can be a cloud server that provides a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform.

A text classification model can be deployed on the server 601 for training. The server 601 can store a large number of training samples, including at least one positive sample set and at least one negative sample set, which are used to train the text combination determining model. For example, after the text combination determining model is obtained through training in a training method in the implementations of the present specification, the well-trained text combination determining model can be directly deployed on the server 601 or the terminal device 602. Usually, the text combination determining model is directly deployed on the server 601. In this implementation of the present application, the text combination determining model is usually used to analyze a question entered by a user and two corresponding to-be-detected texts, to determine whether the two to-be-detected texts can be combined.

In a possible application scenario, the server 601 can be deployed in each region, to reduce a communication latency; or different servers 601 can respectively serve regions corresponding to all terminal devices 602, to balance load. A plurality of servers 601 share data on a blockchain, and the plurality of servers 601 are equivalent to a data sharing system including the plurality of servers 601. For example, the terminal device 602 is located at a location a, and is communicatively connected to the server 601; and the terminal device 602 is located at a location b, and is communicatively connected to another server 601.

In an implementation, FIG. 8 illustrates a text combination determining method according to an implementation of the present specification. The method can be implemented based on a computer program, and can be run on a text combination determining apparatus based on a von Neumann system. The computer program can be integrated into an application, or can be run as an independent tool application.

For example, the text combination determining method includes step S202 and step S204.

S202: Obtain two to-be-detected texts.

A method for obtaining the two to-be-detected texts can be: obtaining a text entered by a user on a terminal device 602 by using a voice, a touch input, etc.; or receiving a to-be-detected text sent from a terminal device 602.

S204: Input the two to-be-detected texts into a text combination determining model, to obtain a determining result regarding whether the two to-be-detected texts can be combined.

In an implementation of the present specification, the text combination determining model is trained based on at least one positive sample set and at least one negative sample set, until the text combination determining model converges, so that the text combination determining model is used to determine whether to combine two texts, to improve accuracy of determining by the text combination determining model. Further, with reference to a currently popular natural language processing model, in the text combination determining model provided in this implementation, one or more fully connected layers are connected in a customized manner after a plurality of encoding layers, to perform feature compression processing on a plurality of feature vectors obtained by the plurality of encoding layers, thereby improving an algorithm effect of the text combination determining model.

It should be noted that the text combination determining model provided in this implementation of the present application can be applied to various application scenarios that include text combination determining, for example, a basic task such as text combination determining in various natural language processing tasks in the medical field, the financial field, or the education field. However, the basic task is always critical to a subsequent task.

The following is an apparatus implementation of the present specification, and can be used to execute the method implementations of the present specification. For details not disclosed in the apparatus implementations of the present specification, references can be made to the method implementations of the present specification.

FIG. 9 is a schematic structural diagram illustrating a training apparatus for a text combination determining model according to an example implementation of the present specification. The training apparatus can be implemented as all or a part of the apparatus by using software, hardware, or a combination thereof. The apparatus includes a sample acquisition module 901 and a model training module 902.

The sample acquisition module 901 is configured to: obtain at least one positive sample set, and obtain at least one negative sample set, a positive sample set in the at least one positive sample set including two texts that cannot be combined, and a negative sample set in the at least one negative sample set including two texts that can be combined. The model training module 902 is configured to train the text combination determining model based on the at least one positive sample set and the at least one negative sample set, until the text combination determining model converges.

In an implementation, the sample acquisition module 901 includes: a sample acquisition unit, configured to obtain at least one to-be-segmented sample text; and a sample segmentation unit, configured to separately segment the to-be-segmented sample text based on a predetermined symbol in the at least one to-be-segmented sample text, to obtain at least one negative sample set.

In an implementation, the sample segmentation unit includes: a target determining subunit, configured to determine a character or word at a middle location in each to-be-segmented sample text as a target character; a symbol detection subunit, configured to: detect whether the predetermined symbol exists in N characters on the left of the target character, and detect whether the predetermined symbol exists in N characters on the right of the target character, N being an integer greater than 1; and a target segmentation subunit, configured to: if the predetermined symbol exists in the N characters on the left of the target character or the predetermined symbol exists in the N characters on the right of the target character, segment each to-be-segmented sample text by using the predetermined symbol as a boundary, to obtain the at least one negative sample set.

In an implementation, the sample segmentation unit includes: a symbol segmentation subunit, configured to segment, based on a location corresponding to each predetermined character in each to-be-segmented sample text, the to-be-segmented sample text by using each predetermined symbol as a boundary, to obtain a negative sample set corresponding to each predetermined symbol.

In an implementation, the text combination determining model includes a plurality of encoders, at least one fully connected layer, and a determining part; the plurality of encoders are configured to encode a text, to obtain a plurality of feature vectors corresponding to the text; the at least one fully connected layer is configured to perform full connection processing on a plurality of feature vectors corresponding to each of at least two texts, to obtain at least one connection result; and the determining part is configured to determine, based on the at least one connection result, whether the at least two texts can be combined.

In an implementation, the at least one fully connected layer includes one or more of the following fully connected layers: a fully connected layer that sequentially connects all feature vectors, a fully connected layer that connects feature vectors corresponding to head characters of all texts, or a fully connected layer that connects a feature vector corresponding to a head character of one of the texts to a feature vector corresponding to a tail character of another one of the texts.

In an implementation, the determining part is configured to: perform constraint processing on the at least one connection result, to obtain a probability that at least two texts can be combined; and determine, based on the probability that the at least two texts can be combined, whether the at least two texts can be combined.

In an implementation, the plurality of encoders are one or more of the following: an encoder of a bidirectional encoder representations from transformers (BERT) model, an encoder of a recurrent neural network, or an encoder of a convolutional neural network.

In this implementation of the present specification, at least one positive sample set and at least one negative sample set are properly constructed. A positive sample set in the at least one positive sample set includes texts that cannot be combined, and a negative sample set in the at least one negative sample set includes texts that can be combined. The text combination determining model can learn, in a self-supervised manner based on the at least one positive sample set and the at least one negative sample set, whether two texts have a relationship of whether the two texts can be combined, until the text combination determining model converges, to improve training efficiency of the text combination determining model. In addition, the text combination determining model is trained for a plurality of rounds based on at least one positive sample and at least one negative sample, so that the text combination determining model whose training is completed has relatively good interference resistance and robustness, and has relatively high accuracy of executing a task of determining whether to combine two texts, to obtain a combined text with complete semantics, and facilitate reading and understanding by a user. It should be noted that, when the training apparatus for a text combination determining model provided in the above implementation performs the training method for a text combination determining model, division into the above functional modules is merely used as an example for description. In practice, the above functions can be allocated to different functional modules for implementation based on a requirement. In other words, an internal structure of a device is divided into different functional modules, to implement all or some of the functions described above. In addition, the implementations of the training apparatus for a text combination determining model and the training method for a text combination determining model provided in the above implementations belong to the same concept. For an implementation process, references can be made to the method implementations. Details are omitted herein for simplicity.

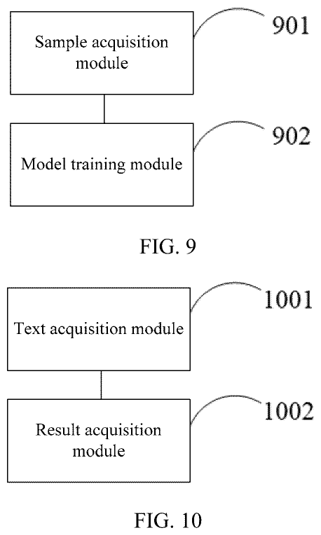

FIG. 10 is a schematic structural diagram illustrating a text combination determining apparatus according to an example implementation of the present specification. The text combination determining apparatus can be implemented as all or a part of the apparatus by using software, hardware, or a combination thereof. The apparatus includes a text acquisition module 1001 and a result acquisition module 1002.

The text acquisition module 1001 is configured to obtain two to-be-detected texts. The result acquisition module 1002 is configured to input the two to-be-detected texts into a text combination determining model, to obtain a determining result regarding whether the two to-be-detected texts can be combined. The text combination determining model is a model obtained through training in the training method for a text combination determining model according to the first aspect.

In this implementation of the present specification, the text combination determining model is trained based on at least one positive sample set and at least one negative sample set, until the text combination determining model converges, so that the text combination determining model is used to determine whether to combine two texts, to improve accuracy of determining by the text combination determining model. Further, with reference to a currently popular natural language processing model, in the text combination determining model provided in this implementation, one or more fully connected layers are connected in a customized manner after a plurality of encoding layers, to perform feature compression processing on a plurality of feature vectors obtained by the plurality of encoding layers, thereby improving an algorithm effect of the text combination determining model.

It should be noted that, when the text combination determining apparatus provided in the above implementation performs the text combination determining method, division into the above functional modules is merely used as an example for description. In practice, the above functions can be allocated to different functional modules for implementation based on a requirement. In other words, an internal structure of a device is divided into different functional modules, to implement all or some of the functions described above. In addition, the implementations of the text combination determining apparatus and the text combination determining method provided in the above implementations belong to the same concept. For an implementation process, references can be made to the method implementations. Details are omitted herein for simplicity.

Sequence numbers of the above implementations of the present specification are merely used for description, and do not represent advantages or disadvantages of the implementations.

An implementation of the present specification further provides a computer storage medium. The computer storage medium can store a plurality of instructions, and the instructions are adapted to be loaded by a processor and to perform the text combination determining method in the implementations shown in FIG. 1 to FIG. 8. For a specific execution process, references can be made to the detailed descriptions in the implementations shown in FIG. 1 to FIG. 8. Details are omitted herein for simplicity.

The present specification further provides a computer program product. The computer program product stores at least one instruction, and the at least one instruction is to be loaded by a processor and to perform the text combination determining method in the implementations shown in FIG. 1 to FIG. 8. For a specific execution process, references can be made to the detailed descriptions in the implementations shown in FIG. 1 to FIG. 8. Details are omitted herein for simplicity.

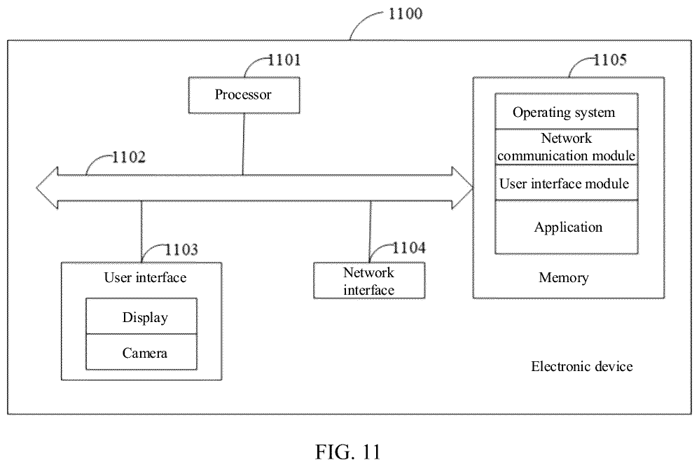

FIG. 11 is a schematic structural diagram illustrating an electronic device according to an implementation of the present specification. As shown in FIG. 11, the electronic device 1100 can include at least one processor 1101, at least one network interface 1104, a user interface 1103, a memory 1105, and at least one communication bus 1102.

The communication bus 1102 is used to implement connection and communication between these components.

The user interface 1103 can include a display and a camera. For example, the user interface 1103 can further include a standard wired interface or wireless interface.

The network interface 1104 can include, for example, a standard wired interface or wireless interface (for example, a Wi-Fi interface).

The processor 1101 can include one or more processing cores. The processor 1101 connects all parts of the entire electronic device 1100 through various interfaces and lines, and performs various functions and data processing of the electronic device 1100 by running or executing instructions, programs, code sets, or instruction sets stored in the memory 1105, and invoking data stored in the memory 1105. For example, the processor 1101 can be implemented in at least one of the following hardware forms: a digital signal processor (DSP), a field-programmable gate array (FPGA), and a programmable logic array (PLA). One or a combination of a central processing unit (CPU), a graphics processing unit (GPU), a modem, etc. can be integrated into the processor 1101. The CPU mainly processes an operating system, a user interface, an application, etc. The GPU is responsible for rendering and drawing content to be displayed on the display. The modem is used to deal with wireless communication. It will be appreciated that the above modem can alternatively be implemented by a single chip without being integrated into the processor 1101.

The memory 1105 can include a random access memory (RAM), or can include a read-only memory. For example, the memory 1105 includes a non-transitory computer-readable medium. The memory 1105 can be configured to store instructions, a program, code, a code set, or an instruction set. The memory 1105 can include a program storage area and a data storage area. The program storage area can store instructions for implementing an operating system, instructions for at least one function (for example, a touch function, a sound playing function, and an image playing function), instructions for implementing the above method implementations, etc. The data storage area can store data used in the above method implementations, etc. For example, the memory 1105 can be at least one storage apparatus far away from the processor 1101. As shown in FIG. 11, the memory 1105 serving as a computer storage medium can include an operating system, a network communication module, a user interface module, and applications. The application is an application of the training method for a text combination determining model and/or an application of the text combination determining method.

In the electronic device 1100 shown in FIG. 11, the user interface 1103 is mainly configured to provide an input interface for a user, to obtain data entered by the user. The processor 1101 can be configured to invoke the application of training of a text combination determining model stored in the memory 1105, and, in some implementations, perform the following operations: obtaining at least one positive sample set, and obtaining at least one negative sample set, a positive sample set in the at least one positive sample set including two texts that cannot be combined, and a negative sample set in the at least one negative sample set including two texts that can be combined; and training the text combination determining model based on the at least one positive sample set and the at least one negative sample set, until the text combination determining model converges.

In an implementation, the processor 1101 obtains the at least one negative sample set, which, in some examples, includes the following operations: obtaining at least one to-be-segmented sample text; and separately segmenting the to-be-segmented sample text based on a predetermined symbol in the at least one to-be-segmented sample text, to obtain at least one negative sample set.

In an implementation, when separately segmenting the to-be-segmented sample text based on a predetermined symbol in the at least one to-be-segmented sample text, to obtain the at least one negative sample set, the processor 1101, in some implementations, performs the following operations: determining a character or word at a middle location in each to-be-segmented sample text as a target character; detecting whether the predetermined symbol exists in N characters on the left of the target character, and detecting whether the predetermined symbol exists in N characters on the right of the target character, N being an integer greater than 1; and if the predetermined symbol exists in the N characters on the left of the target character or the predetermined symbol exists in the N characters on the right of the target character, segmenting each to-be-segmented sample text by using the predetermined symbol as a boundary, to obtain the at least one negative sample set.

In an implementation, when separately segmenting the to-be-segmented sample text based on a predetermined symbol in the at least one to-be-segmented sample text, to obtain the at least one negative sample set, the processor 1101, in some implementations, performs the following operations: segmenting, based on a location corresponding to each predetermined character in each to-be-segmented sample text, the to-be-segmented sample text by using each predetermined symbol as a boundary, to obtain a negative sample set corresponding to each predetermined symbol.

In an implementation, the text combination determining model includes a plurality of encoders, at least one fully connected layer, and a determining part; the plurality of encoders are configured to encode a text, to obtain a plurality of feature vectors corresponding to the text; the at least one fully connected layer is configured to perform full connection processing on a plurality of feature vectors corresponding to each of at least two texts, to obtain at least one connection result; and the determining part is configured to determine, based on the at least one connection result, whether the at least two texts can be combined.

In an implementation, the at least one fully connected layer includes one or more of the following fully connected layers: a fully connected layer that sequentially connects all feature vectors, a fully connected layer that connects feature vectors corresponding to head characters of all texts, or a fully connected layer that connects a feature vector corresponding to a head character of one of the texts to a feature vector corresponding to a tail character of another one of the texts.

In an implementation, the determining part is configured to: perform constraint processing on the at least one connection result, to obtain a probability that at least two texts can be combined; and determine, based on the probability that the at least two texts can be combined, whether the at least two texts can be combined.

In an implementation, the plurality of encoders are one or more of the following: an encoder of a bidirectional encoder representations from transformers (BERT) model, an encoder of a recurrent neural network, or an encoder of a convolutional neural network.

In an implementation, the processor 1101 can be configured to invoke the application of text combination determining stored in the memory 1105, and perform the following operations: obtaining two to-be-detected texts; and inputting the two to-be-detected texts into a text combination determining model, to obtain a determining result regarding whether the two to-be-detected texts can be combined, the text combination determining model being a model obtained through training in the training method for a text combination determining model in the above implementations.

In this implementation of the present specification, at least one positive sample set and at least one negative sample set are properly constructed. A positive sample set in the at least one positive sample set includes texts that cannot be combined, and a negative sample set in the at least one negative sample set includes texts that can be combined. The text combination determining model can learn, in a self-supervised manner based on the at least one positive sample set and the at least one negative sample set, whether two texts have a relationship of whether the two texts can be combined, until the text combination determining model converges, to improve training efficiency of the text combination determining model. In addition, the text combination determining model is trained for a plurality of rounds based on at least one positive sample and at least one negative sample, so that the text combination determining model whose training is completed has relatively good interference resistance and robustness, and has relatively high accuracy of executing a task of determining whether to combine two texts, to obtain a combined text with complete semantics, and facilitate reading and understanding by a user. A person of ordinary skill in the art can understand that all or some of the procedures of the methods in the above implementations can be implemented by a computer program instructing related hardware. The program can be stored in a computer-readable storage medium. When the program is executed, the procedures in the method implementations can be included. The storage medium can be a magnetic disk, an optical disc, a read-only storage memory, a random storage memory, etc.

Merely example implementations of the present specification are described herein. Certainly, the claims of the present specification cannot be limited thereto. Therefore, equivalent changes made according to the claims of the present specification still fall within the scope of the present specification.

What is claimed is:

1. A method for training a text combination determining model, the method comprising:
obtaining at least one positive sample set and obtaining at least one negative sample set, a positive sample set of the at least one positive sample set including two texts that cannot be combined, and a negative sample set of the at least one negative sample set including two texts that can be combined; and
training the text combination determining model based on the at least one positive sample set and the at least one negative sample set.

2. The method according to claim 1, wherein the obtaining the at least one negative sample set includes:
obtaining at least one to-be-segmented sample text; and
separately segmenting a to-be-segmented sample text of the at least one to-be-segmented sample text based on a determined symbol in the to-be-segmented sample text, to obtain at least one negative sample set.

3. The method according to claim 2, wherein the separately segmenting the to-be-segmented sample text based on a determined symbol includes:
determining a character at a middle location in the to-be-segmented sample text as a target character;
detecting one or more of whether the determined symbol exists in N characters on a left of the target character or whether the determined symbol exists in N characters on a right of the target character, N being an integer greater than 1; and
in response to that the determined symbol exists in the N characters on the left of the target character or the determined symbol exists in the N characters on the right of the target character, segmenting the to-be-segmented sample text by using the determined symbol as a boundary.

4. The method according to claim 2, wherein the separately segmenting the to-be-segmented sample text based on a determined symbol includes:
segmenting, based on a location corresponding to the determined symbol in the to-be-segmented sample text, the to-be-segmented sample text by using the determined symbol as a boundary, to obtain a negative sample set corresponding to the determined symbol.

5. The method according to claim 1, wherein the text combination determining model includes a plurality of encoders, at least one fully connected layer, and a determining part;
the plurality of encoders are configured to encode a text, to obtain a plurality of feature vectors corresponding to the text;
the at least one fully connected layer is configured to perform full connection processing on a plurality of feature vectors corresponding to each of at least two texts, to obtain at least one connection result; and
the determining part is configured to determine, based on the at least one connection result, whether the at least two texts can be combined.

6. The method according to claim 5, wherein the at least one fully connected layer includes one or more of:
a fully connected layer that sequentially connects feature vectors,
a fully connected layer that connects feature vectors corresponding to head characters of texts, or
a fully connected layer that connects a feature vector corresponding to a head character of one of the texts to a feature vector corresponding to a tail character of another one of the texts.

7. The method according to claim 5, wherein the determining part is configured to:
perform constraint processing on the at least one connection result, to obtain a probability that the at least two texts can be combined; and
determine, based on the probability that the at least two texts can be combined, whether the at least two texts can be combined.

8. The method according to claim 5, wherein the plurality of encoders include one or more of:
an encoder of a bidirectional encoder representations from transformers (BERT) model, an encoder of a recurrent neural network, or an encoder of a convolutional neural network.

9. The method according to claim 1, comprising:
obtaining two to-be-detected texts; and
inputting the two to-be-detected texts into the text combination determining model, to obtain a determining result regarding whether the two to-be-detected texts can be combined.

10. A computing system comprising one or more processors and one or more storage devices, the one or more storage device, individually or collectively, having computer executable instructions stored thereon, the computer executable instructions, when executed by the one or more processors, enabling the one or more processors to, individually or collectively, implement a text combination determining model and actions including:
obtaining at least one positive sample set and obtaining at least one negative sample set, a positive sample set of the at least one positive sample set including two texts that cannot be combined, and a negative sample set of the at least one negative sample set including two texts that can be combined; and
training the text combination determining model based on the at least one positive sample set and the at least one negative sample set.

11. The computing system according to claim 10, wherein the obtaining the at least one negative sample set includes:
obtaining at least one to-be-segmented sample text; and
separately segmenting a to-be-segmented sample text of the at least one to-be-segmented sample text based on a determined symbol in the to-be-segmented sample text, to obtain at least one negative sample set.

12. The computing system according to claim 11, wherein the separately segmenting the to-be-segmented sample text based on a determined symbol includes:
determining a character at a middle location in the to-be-segmented sample text as a target character;
detecting one or more of whether the determined symbol exists in N characters on a left of the target character or whether the determined symbol exists in N characters on a right of the target character, N being an integer greater than 1; and
in response to that the determined symbol exists in the N characters on the left of the target character or the determined symbol exists in the N characters on the right of the target character, segmenting the to-be-segmented sample text by using the determined symbol as a boundary.

13. The computing system according to claim 11, wherein the separately segmenting the to-be-segmented sample text based on a determined symbol includes:
segmenting, based on a location corresponding to the determined symbol in the to-be-segmented sample text, the to-be-segmented sample text by using the determined symbol as a boundary, to obtain a negative sample set corresponding to the determined symbol.

14. The computing system according to claim 10, wherein the text combination determining model includes a plurality of encoders, at least one fully connected layer, and a determining part;
the plurality of encoders are configured to encode a text, to obtain a plurality of feature vectors corresponding to the text;
the at least one fully connected layer is configured to perform full connection processing on a plurality of feature vectors corresponding to each of at least two texts, to obtain at least one connection result; and
the determining part is configured to determine, based on the at least one connection result, whether the at least two texts can be combined.

15. The computing system according to claim 14, wherein the at least one fully connected layer includes one or more of:
a fully connected layer that sequentially connects feature vectors,
a fully connected layer that connects feature vectors corresponding to head characters of texts, or
a fully connected layer that connects a feature vector corresponding to a head character of one of the texts to a feature vector corresponding to a tail character of another one of the texts.

16. The computing system according to claim 14, wherein the determining part is configured to:
perform constraint processing on the at least one connection result, to obtain a probability that the at least two texts can be combined; and
determine, based on the probability that the at least two texts can be combined, whether the at least two texts can be combined.

17. The computing system according to claim 14, wherein the plurality of encoders include one or more of: an encoder of a bidirectional encoder representations from transformers (BERT) model, an encoder of a recurrent neural network, or an encoder of a convolutional neural network.

18. The computing system according to claim 10, wherein the actions include:
obtaining two to-be-detected texts; and
inputting the two to-be-detected texts into the text combination determining model, to obtain a determining result regarding whether the two to-be-detected texts can be combined.

19. A computer storage medium, the computer storage medium storing a plurality of instructions, and the instructions being adapted to be executed by one or more processors to, individually or collectively, implement a text combination determining model and actions including:
obtaining at least one positive sample set and obtaining at least one negative sample set, a positive sample set of the at least one positive sample set including two texts that cannot be combined, and a negative sample set of the at least one negative sample set including two texts that can be combined; and
training the text combination determining model based on the at least one positive sample set and the at least one negative sample set.

20. The computer storage medium according to claim 19, wherein the obtaining the at least one negative sample set includes:
obtaining at least one to-be-segmented sample text; and
separately segmenting a to-be-segmented sample text of the at least one to-be-segmented sample text based on a determined symbol in the to-be-segmented sample text, to obtain at least one negative sample set.
